(19) United States
(12) Patent Application Publication
(10) Pub. No.: US 2025/0379938 A1
(43) Pub. Date: Dec. 11, 2025

(54) Mitigating Robocalls Using Connected Cars

(71) Applicant: AT&T Intellectual Property I, L.P., Atlanta, GA (US)

(72) Inventors: Yaron Koral, Cherry Hill, NJ (US); Hasit Dani, Hillsborough, NJ (US)

(73) Assignee: AT&T Intellectual Property I, L.P., Atlanta, GA (US)

(21) Appl. No.: 18/734,403

(22) Filed: Jun. 5, 2024

(51) Int. Cl. H04M 3/436; H04W 4/16

(52) U.S. Cl. CPC H04M 3/4365; H04W 4/16

(57) ABSTRACT

A robocall mitigation system can receive a call detail record (“CDR”) associated with a voice call conducted over a mobile telecommunications network. The robocall mitigation system can determine, from the CDR, an originating telephone number and a destination telephone number for the voice call. The robocall mitigation system can determine that the destination telephone number is associated with a connected vehicle. The robocall mitigation system can compare the originating telephone number to a set of authorized originating telephone numbers. The robocall mitigation system can determine, based upon comparing the originating telephone number to the set of authorized originating telephone numbers, that the originating telephone number was unauthorized. The robocall mitigation system can generate a robocall alert record. The robocall mitigation system can output the robocall alert record.

### BACKGROUND

Robocalls are automated voice calls placed to millions of destinations each day. For customers, robocalls are mainly a source of annoyance, but many times may result in the customer being scammed or defrauded. For network providers, robocalls consume expensive radio access network (“RAN”) resources. Identifying the originating telephone number for robocalls is not easy because robocalls frequently change or spoof the originating number. A network provider cannot block a suspected robocall unless the network provider knows that a call is indeed malicious.

### SUMMARY

Concepts and technologies disclosed herein are directed to mitigating robocalls using connected cars. According to one aspect of the concepts and technologies disclosed herein, a robocall mitigation system can receive a call detail record (“CDR”) associated with a voice call conducted over a mobile telecommunications network. The robocall mitigation system can determine, by a robocall campaign detection module executed by a processor of the robocall mitigation system, from the call detail record, an originating telephone number and a destination telephone number for the voice call. The robocall mitigation system can determine, by the robocall campaign detection module, that the destination telephone number is associated with a connected vehicle. The robocall mitigation system can compare, by the robocall campaign detection module, the originating telephone number to a set of authorized originating telephone numbers. The robocall mitigation system can determine, by the robocall campaign detection module, based upon comparing the originating telephone number to the set of authorized originating telephone numbers, that the originating telephone number was unauthorized. The robocall mitigation system can generate, by the robocall campaign detection module, a robocall alert record. The robocall mitigation system can output, by the robocall campaign detection module, the robocall alert record.

In some embodiments, the robocall mitigation system can determine, by the robocall campaign detection module, a set of robocall campaign features associated with a robocall campaign. The robocall mitigation system can cluster, by the robocall campaign detection module using a clustering algorithm, based upon the set of features, the robocall alert record with additional robocall alert records. The robocall mitigation system can then output, by the robocall campaign detection module, a robocall campaign cluster. The robocall mitigation system can output the robocall campaign cluster to a robocall protection enrichment module. The robocall protection enrichment module can add robocall data associated with the robocall campaign cluster to a robocall protection technique implemented by an external robocall blocking system. The robocall protection technique may include a crowdsourcing technique, a challenge-response test, a real-time analysis, a stir/shaken technique, or a combination thereof. The robocall mitigation system can output the robocall campaign cluster to a connected vehicle robocall blocking module. The connected vehicle robocall blocking module can block a plurality of robocalls associated with the robocall campaign.

In some embodiments, the robocall mitigation system can output, by the robocall campaign detection module, the robocall alert record to a connected vehicle robocall blocking module. The robocall mitigation system can block, by the connected vehicle robocall blocking module, a plurality of robocalls associated with the originating telephone number and associated with a plurality of destination telephone numbers corresponding to a plurality of connected cars. The robocall mitigation system can block, by the connected vehicle robocall blocking module, the plurality of robocalls at a core network function of the mobile telecommunications network.

It should be appreciated that the above-described subject matter may be implemented as a computer-controlled apparatus, a computer process, a computing system, or as an article of manufacture such as a computer-readable storage medium. These and various other features will be apparent from a reading of the following Detailed Description and a review of the associated drawings.

This Summary is provided to introduce a selection of concepts in a simplified form that are further described below in the Detailed Description. This Summary is not intended to identify key features or essential features of the claimed subject matter, nor is it intended that this Summary be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 is a block diagram illustrating aspects of an operating environment in which aspects of the concepts and technologies disclosed herein can be implemented.

FIG. 2 is a block diagram illustrating additional components of a robocall campaign detection module, according to an illustrative embodiment of the concepts and technologies disclosed herein.

FIG. 3 is a block diagram illustrating an example robocall campaign and associated robocall campaign features.

FIG. 4 is a block diagram illustrating example machine learning processes that can be used by a robocall campaign detection module, according to an illustrative embodiment of the concepts and technologies disclosed herein.

FIG. 5 is a block diagram illustrating an example false positive analysis that can be used by a robocall campaign detection module, according to an illustrative embodiment of the concepts and technologies disclosed herein.

FIG. 6 is a block diagram illustrating an example probability analysis that can be used by a robocall campaign detection module, according to an illustrative embodiment of the concepts and technologies disclosed herein.

FIG. 7 is a block diagram illustrating example of robocall protection techniques that can be enhanced using the concepts and technologies disclosed herein.

FIG. 8 is a flow diagram illustrating aspects of a method for mitigating robocalls using connected vehicles, according to an illustrative embodiment of the concepts and technologies disclosed herein.

FIG. 9 is a block diagram illustrating an example computer system capable of implementing aspects of the concepts and technologies disclosed herein.

FIG. 10 is a block diagram illustrating an example mobile device capable of implementing aspects of the concepts and technologies disclosed herein.

FIG. 11 is a block diagram illustrating an example network functions virtualization (“NFV”) platform capable of implementing aspects of the concepts and technologies disclosed herein.

FIG. 12 is a block diagram illustrating an example network capable of implementing aspects of the concepts and technologies disclosed herein.

FIG. 13 is a block diagram illustrating an example machine learning system capable of implementing aspects of the concepts and technologies disclosed herein.

### DETAILED DESCRIPTION

Robocall operators use various techniques to avoid detection by changing originating phone numbers or spoofing numbers that seem legit. A mobile network operator (“MNO”) provides cellular services to various types of customers, among them are connected car companies. These customers are a significant part of a network's customer base, having tens of millions of devices. The concepts and technologies disclosed herein takes advantage of this subset of customers to identify and block robocalls, since connected cars are intended to receive only voice calls from a small set of originating numbers. Blocking robocalls to these connected cars can save expensive RAN resources allocated for these unwanted calls. Moreover, using connected cars can act as a honey pot to mark robocall sources, helping the rest of the network block known robocall numbers. Mitigating the effects of robocalls is a primary goal of MNOs. The concepts and technologies disclosed herein can save valuable network resources, reduce operating costs, and provide an additional revenue stream by offering a robocall mitigation service that can be sold as an application programming interface (“API”) for detecting and blocking robocall numbers.

While the subject matter described herein may be presented, at times, in the general context of program modules that execute in conjunction with the execution of an operating system and application programs on a computer system, those skilled in the art will recognize that other implementations may be performed in combination with other types of program modules. Generally, program modules include routines, programs, components, data structures, computer-executable instructions, and/or other types of structures that perform particular tasks or implement particular abstract data types. Moreover, those skilled in the art will appreciate that the subject matter described herein may be practiced with other computer systems, including hand-held devices, Drones, wireless devices, multiprocessor systems, distributed computing systems, microprocessor-based or programmable consumer electronics, minicomputers, mainframe computers, routers, switches, other computing devices described herein, and the like.

In the following detailed description, references are made to the accompanying drawings that form a part hereof, and in which are shown by way of illustration specific embodiments or examples. Referring now to the drawings, in which like numerals represent like elements throughout the several figures, aspects of mitigating robocalls using connected cars will be presented.

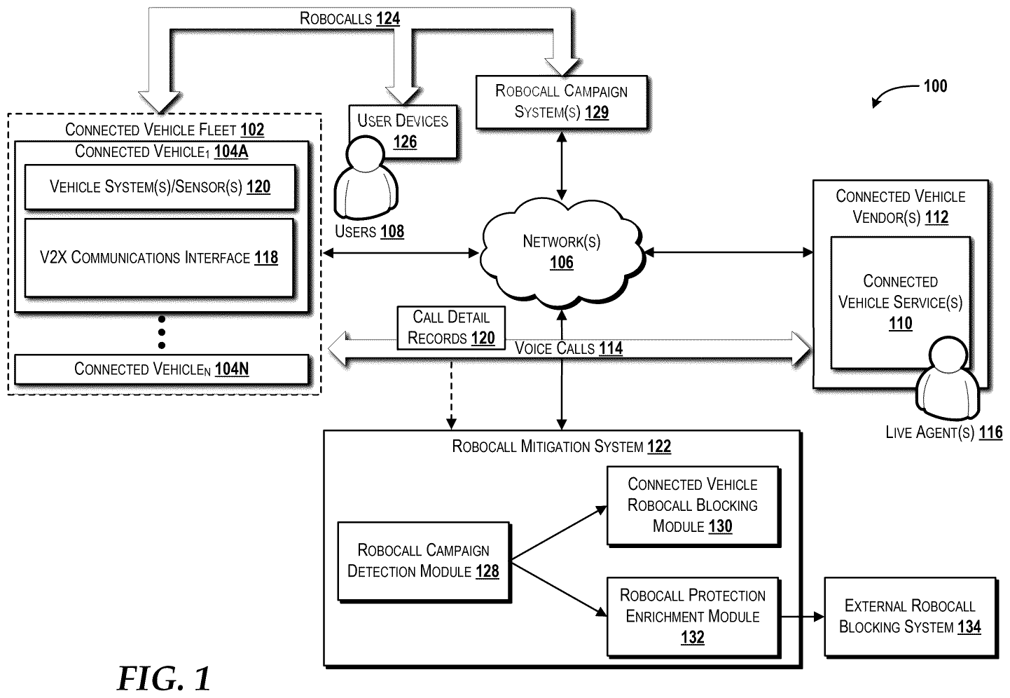

Referring now to FIG. 1, aspects of an illustrative operating environment 100 for various concepts disclosed herein will be described. It should be understood that the operating environment 100 and the various components thereof have been greatly simplified for purposes of discussion. Accordingly, additional or alternative components of the operating environment 100 can be made available without departing from the embodiments described herein. The operating environment 100 shown in FIG. 1 includes a connected vehicle fleet 102 that includes a plurality of connected vehicles 104A-104N (hereafter referred to individually as “connected vehicle 104” or collectively as “connected vehicles 104”). The connected vehicles 104 can connect to and operate in communication with one or more networks 106, such as one or more mobile telecommunications networks.

Each of the connected vehicles 104 can be a car, truck, van, motorcycle, moped, go-kart, golf cart, tank, ATV, or any other ground-based vehicle. It should be understood, however, that aspects of the concepts and technologies disclosed herein can extend to other vehicles that have amphibious and/or flight capabilities. The connected vehicles 104 can accommodate any number of vehicle occupants (shown as “users 108”), each of whom can be a driver or a passenger of one of the connected vehicles 104.

The connected vehicles 104 can be human-operated, autonomous, or partially autonomous. As an autonomous vehicle, the connected vehicle 104 can have multiple modes, including, for example, a driver-operated mode, a partially autonomous control mode, and a fully autonomous control mode. In some embodiments, the connected vehicles 104 can operate as Level 3 or Level 4 vehicles as defined by the National Highway Traffic Safety Administration (“NHTSA”). The NHTSA defines a Level 3 vehicle as a limited self-driving automation vehicle that enables a driver to cede full control of all safety-critical functions under certain traffic or environmental conditions and in those conditions to rely heavily on the connected vehicle 104 to monitor for changes in those conditions requiring transition back to driver control. The driver is expected to be available for occasional control, but with sufficiently comfortable transition time. The NHTSA defines a Level 4 vehicle as a full self-driving automation vehicle that is designed to perform all safety-critical driving functions and monitor roadway conditions for an entire trip to a destination. Such a design anticipates that the driver will provide destination or navigation input, but is not expected to be available for control at any time during the trip.

The manufacturer, vehicle type (e.g., car, truck, van, etc.), and/or vehicle specification, including, but not limited to, occupant capacity, gross vehicle weight, towing capacity, engine type (e.g., internal combustion, electric, or hybrid), energy type (e.g., fuel, battery, or hybrid), motor/engine size, drive type (e.g., front wheel drive, rear wheel drive, all-wheel drive, or four wheel drive), engine location (e.g., front, mid, or rear), and transmission type (e.g., manual, automatic, dual clutch, continuously variable, etc.) of the connected vehicles 104 should not be limited in any way. The concepts and technologies disclosed herein are applicable to all connected vehicles 104 that have, at a minimum, a ground-based operational mode. Moreover, human-powered vehicles such as bicycles, scooters, and the like are also contemplated, although those skilled in the art will appreciate that some aspects of the concepts and technologies disclosed herein may not be applicable to these vehicle types.

The connected vehicle fleet 102 can include connected vehicles 104 of the same make, model, trim, or some combination thereof. The connected vehicle fleet 102 can include connected vehicles 104 sold, leased, or rented for personal or commercial use. The connected vehicle fleet 102 can include connected vehicles 104 that utilize one or more connected vehicle services 110 provided by one or more connected vehicle vendors 112. The connected vehicle vendor(s) 112 can include vehicle manufacturers, connected vehicle service providers, other service providers (e.g., telecommunications service providers such as mobile network operators), other companies, individuals, entities, or any combination thereof.

The connected vehicle services 110 can include any services provided to one or more of the connected vehicles 104 via the network(s) 106. The connected vehicle services 110 will be described as being provided to one or more of the connected vehicles 104 through one or more mobile terminated voice calls (“voice calls”) 114 handled by a voice service provided by the network(s) 106. By way of example, and not limitation, the connected vehicle services 110 can be or can include a navigation service (e.g., turn-by-turn driving directions to a destination), a search service (e.g., point of interest search), and/or a concierge service (e.g., restaurant reservations) provided by one or more live agents 116, although pre-recorded and/or automated calls are also contemplated in addition to or as an alternative to the live agents 116.

The connected vehicle services 110 can interact with the connected vehicles 104 via a vehicle-to-everything (“V2X”) communications interface 118 on the connected vehicles 104 (best shown as part of connected vehicle₁ 104A). The V2X communications interface 118 enables the connected vehicle 104 to communicate with one or more other entities, such other connected vehicles 104 within the same and/or different connected vehicle fleets 102, other vehicles (not shown), a vehicle-to-cloud (“V2C”) platform (not shown), a vehicle-to-infrastructure (“V2I”) platform (not shown), and other vehicle-to-X platforms disclosed herein as will be described in greater detail below. The V2X communications interface 118 can be or can include a cellular interface, a WLAN interface, a short-range communications interface, or a combination thereof. In some embodiments, the V2X communications interface 118 is based upon a standard specification such as IEEE 802.11p (i.e., for WLAN-based V2X technology) or 3GPP C-V2X (i.e., for cellular-based V2X technology). It should be understood that as of the filing date of this patent application, V2X technology is in its infancy and the technology has not yet been widely adopted. Organizations, such as the 5G Automotive Association (“5GAA”), exist to promote the use of V2X technology. Accordingly, those skilled in the art will appreciate that the V2X communications interface 118 can be embodied in accordance with existing standards, but will likely change over time as V2X technology matures. The V2X communications interface 118 should be construed as being compatible with both current and future V2X standards. Moreover, proprietary technologies that enable V2X-type communication are also contemplated.

A vehicle system(s)/sensor(s) 120 can include one or more systems associated with any aspect of the connected vehicle 104. For example, vehicle system(s)/sensor(s) 120 can include the engine/motor, fuel system, ignition system, electrical system, charging system, battery system, exhaust system, drivetrain system, suspension system, steering system, braking system, parking assistance system (e.g., parking sensors), navigation system, radio system, infotainment system, communication system (e.g., in-car WI-FI and/or cellular connectivity), BLUETOOTH and/or other connectivity systems that allow connectivity with other systems, devices, and/or networks disclosed herein, driver assistance system (e.g., lane departure warning, lane keep assist, blind spot monitoring, parking assist, cruise control, automated cruise control, autonomous mode, semi-autonomous mode, and the like), tire pressure monitoring systems, combinations thereof, and the like.

The vehicle system(s)/sensor(s) 120 can provide output to one or more sensor controllers that can utilize the output to perform various vehicle operations. Modern vehicles have numerous systems that are controlled, at least in part, based upon the output of multiple sensors, including, for example, sensors associated with the operation of various vehicle components such as the drivetrain (e.g., engine, transmission, and differential), brakes, suspension, steering, and safety components. Output from sensors such as cameras, proximity sensors, radar sensors, and light detection and ranging (“LiDAR”) sensors can aid in providing the connected vehicle 104 with information about the environment surrounding the connected vehicle 104, other vehicles (not shown), and pedestrians (also not shown). Those skilled in the art will appreciate the use of these and/or other similar sensors to enable the connected vehicles 104 to detect and classify objects in the environment (e.g., distinguish between roadside objects, other vehicles, and pedestrians), to perform self-driving operations (e.g., accelerate, decelerate, brake, change lanes, obey traffic signs and signals, and avoid collisions and accidents), and/or to perform other operations.

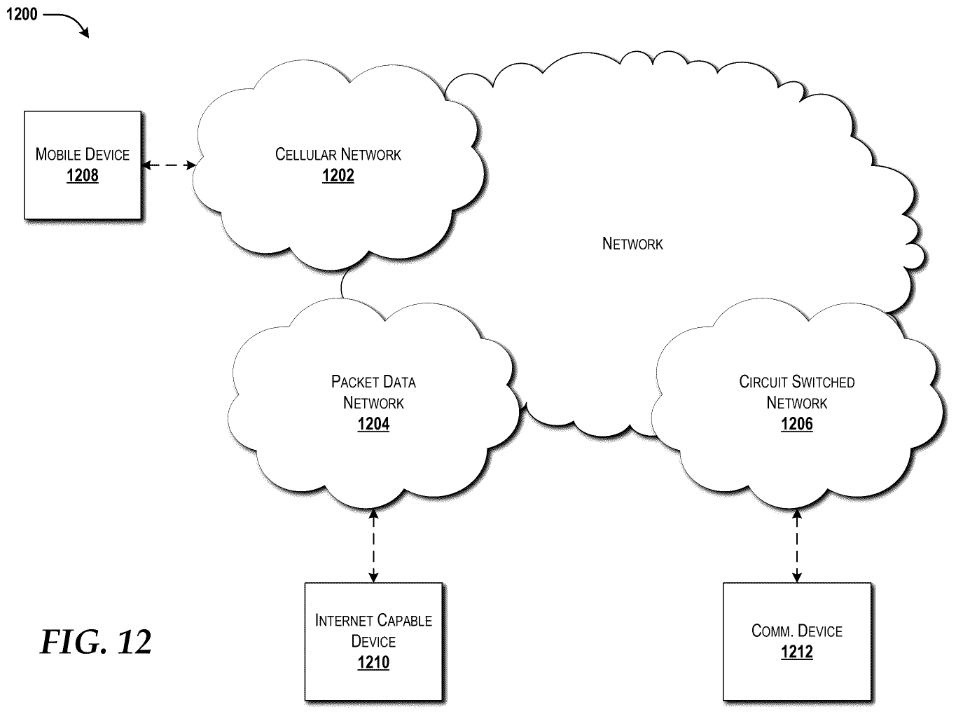

The network(s) 106 can be or can include one or more mobile telecommunications networks (e.g., wireless wide area network(s) “WWANs”) operated by one or more mobile network operators. The WWANs may, in turn, include one or more core networks such as a circuit-switched core network (“CS CN”), a packet-switched core network (“PS CN”), an IP multimedia subsystem (“IMS”) core network, multiples thereof, and/or combinations thereof. The WWAN can utilize one or more mobile telecommunications technologies, such as, but not limited to, Global System for Mobile communications (“GSM”), Code Division Multiple Access (“CDMA”) ONE, CDMA2000, Universal Mobile Telecommunications System (“UMTS”), Long-Term Evolution (“LTE”), Worldwide Interoperability for Microwave Access (“WiMAX”), other 802.XX technologies (e.g., 802.11 WI-FI), and the like. The networks 106 can include one or more radio access networks (“RANs”). A RAN can utilize various channel access methods (which might or might not be used by the aforementioned standards) including, but not limited to, Time Division Multiple Access (“TDMA”), Frequency Division Multiple Access (“FDMA”), Single Carrier FDMA (“SC-FDMA”), CDMA, wideband CDMA (“W-CDMA”), Orthogonal Frequency Division Multiplexing (“OFDM”), Space Division Multiple Access (“SDMA”), and/or the like to provide a radio/air interface to the V2X communications interface 118 on the connected vehicles 104. Data communications can be provided in part by a RAN using General Packet Radio Service (“GPRS”), Enhanced Data rates for Global Evolution (“EDGE”), the High-Speed Packet Access (“HSPA”) protocol family including High-Speed Downlink Packet Access (“HSDPA”), Enhanced Uplink (“EUL”) or otherwise termed High-Speed Uplink Packet Access (“HSUPA”), Evolved HSPA (“HSPA+”), LTE, and/or various other current and future wireless data access technologies. Moreover, a RAN may be a GSM RAN (“GRAN”), a GSM EDGE RAN (“GERAN”), a UMTS Terrestrial Radio Access Network (“UTRAN”), an E-UTRAN, 5G New Radio (“NR”), any combination thereof, and/or the like. Those skilled in the art will appreciate the use of colloquial terms such as 1G, 2G, 3G, 4G, and 5G to describe different generations of the aforementioned technologies. An example configuration of the network 106 is illustrated and described herein with reference to FIG. 12.

The network(s) 106 can handle the voice calls 114 between the connected vehicle(s) 104, and particularly the associated V2X communications interface(s) 118, and the connected vehicle service(s) 110 provided by the connected vehicle vendor(s) 112. The network(s) 106 can record details of the voice calls 114 as part of call detail records (“CDRs”) 120. Each of the CDRs 120 can identify an originating telephone number of a voice call 114, an originating party of the voice call 114, a destination telephone number of the voice call 114, a destination party of the voice call 114, a date and a time the voice call 114 was made, a duration of the voice call 114, and other usage and diagnostic information.

A robocall mitigation system 122 can monitor the voice calls 114 and use information contained in the CDRs 120 associated with the voice calls 114 to identify one or more robocalls 124. The robocall mitigation system 122 can identify the robocall(s) 124 based upon the successful termination and the duration of the voice calls 114. The robocall mitigation system 122 can then use this information to block future robocalls 124 directed to the connected vehicles 104. In addition, the robocall mitigation system 122 can mark spamming originating telephone numbers and use these telephone numbers to block the robocalls 124 to other devices, such as one or more user devices 126, operating in communication with the network(s) 106. Using the connected vehicle 104 population as a method to identify the robocalls 124 is helpful due to the population of connected vehicles 104 in the real-world (e.g., tens of millions of vehicles) as compared to the overall population of devices connected to the network(s) 106. Moreover, identifying different classes of robocalls 124 that are destined to the connected vehicles 104 is considerably easier than doing the same for robocalls 124 destined to consumer telephones, such as the user devices 126, because the benign calls to the connected vehicles 104 are more structured and limited as compared to calls to consumer telephones. Although each connected vehicle vendor 112 may have a different set of voice services (e.g., part of the connected vehicle service(s) 110), an MNO can capture a pattern of benign voice calls to the connected vehicles 104 served by a particular connected vehicle vendor 112. For example, a connected vehicle vendor 112 may implement a single voice call service of emergency calls. In the event of a car accident, the connected vehicle 104 can automatically send a crash report (e.g., location, sensor data, airbag deployment, etc.) to the connected vehicle service 110, and an operator, such as one of live agents 116, in response, can call back to the connected vehicle 104 to help. Another scenario is if the driver requests roadside assistance, the live agent 116 can call back to a telephone number associated with the connected vehicle 104. In both cases, the voice call 114 is initiated by a small set of phone numbers (e.g., five or fewer). Also, the volume of voice calls 114 directed to the connected vehicles 104 is relatively low compared to the total number of voice calls 114 served by the network(s) 106. For connected vehicles 104 that belong to this particular connected vehicle vendor 112, the robocall mitigation system 122 could mark any incoming voice call that is not part of the small set of operator phone numbers as a suspicious number.

The user devices 126 can be configured to communicate with one or more of the connected vehicles 104 via a wired connection, a wireless connection, or both. In some embodiments, the user devices 126 can communicate with the connected vehicles 104 via a short-range communication technology such as BLUETOOTH. Other wireless technologies such as Wi-Fi are also contemplated. Wired connections may be facilitated by a universal serial bus (“USB”)-based connection, although other wired connection types, including proprietary connection types are also contemplated. Moreover, the user devices 126 may communicate directly or via some other interface with the connected vehicles 104 through the vehicle system(s)/sensor(s) 120. In some embodiments, the user devices 126 can be integrated (permanently or temporarily) with the connected vehicles 104 such as part of the vehicle system(s)/sensor(s) 120. The user devices 126 may be retrofitted into the connected vehicles 104 as aftermarket equipment or may be made available as standard or optional original equipment manufacturer (“OEM”) equipment of the connected vehicle 104. The user devices 126 can utilize output from vehicle system(s)/sensor(s) 120 to perform various operations.

The concepts and technologies disclosed herein can be extended to use Internet of Things (“IoT”) services as an alternative to or in addition to the connected vehicles 104 to identify potential robocalls 124. In particular, IoT services that utilize a small and known set of authorized originating telephone numbers (e.g., ten or fewer), may have common call patterns that can be predicted. Moreover, IoT services provide a relatively large population of devices compared to the total number of devices served by a network. As such, IoT services may be used as an alternative to the connected vehicles 104 or in addition to the connected vehicles 104 to identify potential robocalls 124.

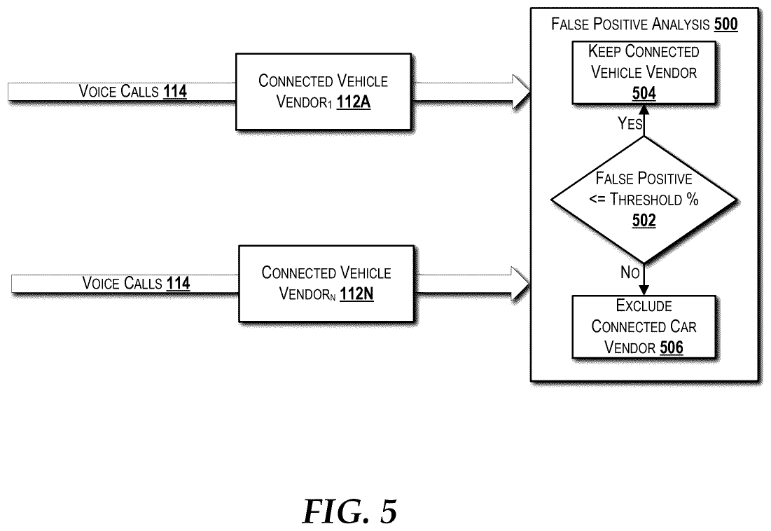

The illustrated robocall mitigation system 122 includes three main modules—a robocall campaign detection module 128, a connected vehicle robocall blocking module 130, and a robocall protection enrichment module 132. These modules 128, 130, 132 can be executed by one or more processors (best shown in FIG. 5) of the robocall mitigation system 122 to perform various operations described herein.

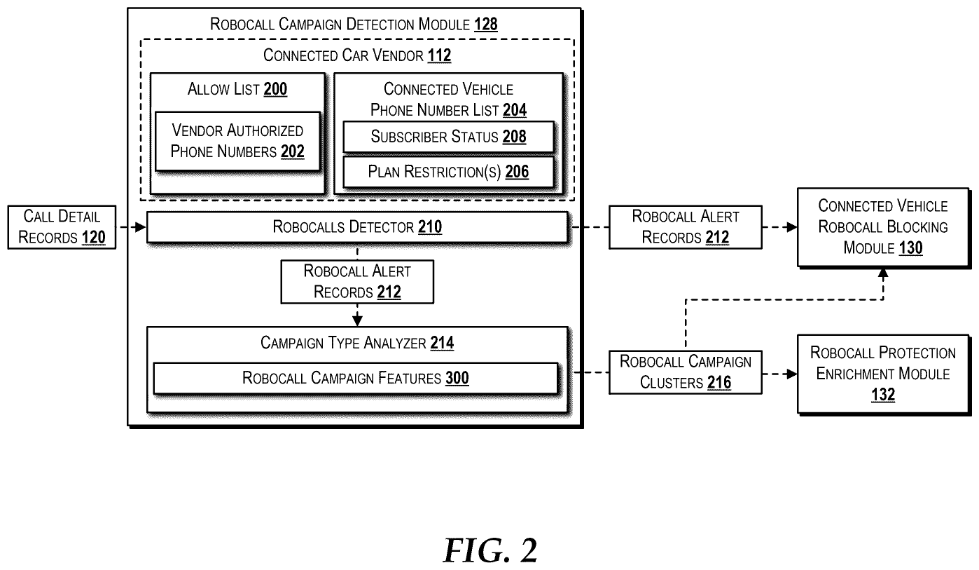

Turning briefly to FIG. 2, components of the robocall campaign detection module 128 will be described, according to an illustrative embodiment. The robocall campaign detection module 128 can identify network call events from unauthorized originating numbers and can classify these call events based upon one or more properties. To identify a network call event as a suspected robocall 124 instead of a benign voice call 114, the robocall campaign detection module 128 can maintain, for each connected vehicle vendor 112, an allow list 200 that contains a relatively small list (e.g., 10 or fewer) of vendor authorized phone numbers 202. The robocall campaign detection module 128 also can maintain a connected vehicle phone number list 204 of the phone numbers used by the connected vehicle 104 itself. The size of the connected vehicle phone number lists 204 may depend on the size of the specific vendor's connected vehicle fleet 102 and may consist of several million telephone numbers, for example. The allow list 200 is typically static in nature and is rarely updated except, for example, whenever there are service changes. The connected vehicle phone number list 204 is dynamic and may be frequently updated such as on a daily basis. In addition to phone numbers, the connected vehicle phone number list 204 can include information about plan restrictions (shown as “plan restriction(s) 206”) for certain subscribers, such as whether voice calls are allowed at all. A subscriber status 208 is another parameter in the connected vehicle phone number list 204. The subscriber status 208 indicates whether the connected vehicle's 104 phone number is activated, waiting to be activated (i.e., vehicle was not sold to a customer yet), or deactivated (i.e., vehicle is no longer in service).

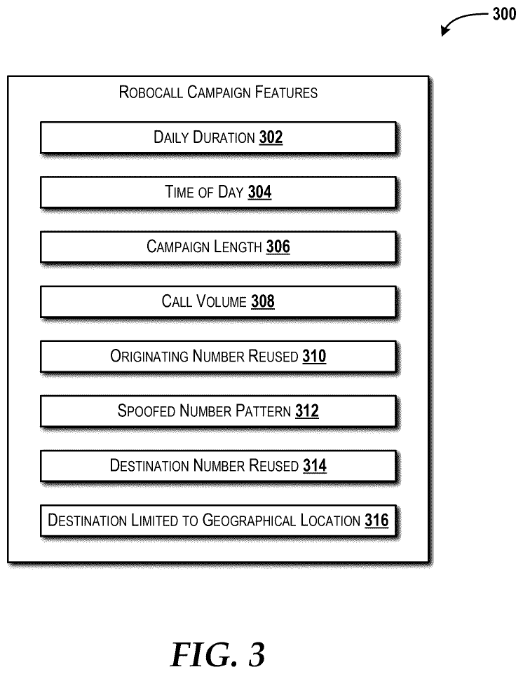

The robocall campaign detection module 128 also includes a robocalls detection component 210 (“robocalls detector 210”) that receives as an input the CDRs 120 collected by the MNO. Whenever the robocalls detector 210 observes a CDR 120 from an originating number that is not in the allow list 200 for one of the numbers within the connected vehicle phone number list 204, the robocalls detector 210 generates a robocall alert record 212 and sends the robocall alert record 212 to a campaign type analysis component 214 (“campaign type analyzer 214”). It should be noted that at this point, any robocalls 124 are typically part of a robocall campaign conducted by one or more robocall campaign systems 129 (best shown in FIG. 1) that are designed to automatically and systematically target a list of destination numbers. Furthermore, a single robocall is of little interest, as it incurs little actual damage other than a minor annoyance to the recipient. A robocall campaign, however, may conduct thousands or millions of robocalls 124 that utilize limited resources available in the network(s) 106. An example robocall campaign may have a list of robocall campaign features 300 such as illustrated in FIG. 3, which will now be described.

Turning briefly to FIG. 3, an example list of robocall campaign features 300 will be described. The list of robocall campaign features 300 includes a daily duration 302 (e.g., in hours/minutes/seconds such as 2 H/29 M/10 S), a time of day 304 (e.g., a specific time range such as between 8:52:04-13:07:20), a campaign length 306 (e.g., 11 days), a call volume 308 (e.g., 283K calls/minute), an indication of whether an originating number is to be reused (“originating number reused” 310) (e.g., yes or no), a spoofed number pattern 312 (e.g., same area code, same number range, and/or same number sequence ”), an indication of whether a destination number is to be reused (“destination number reused” 314) (e.g., yes or no), and an indication of whether a destination is limited to a geographical location (“destination limited to geographical location” 316) (e.g., yes or no). Thus, an example robocall campaign may have a daily average duration of roughly two and a half hours, may take place after 8:52 and before 13:07, and may last for 11 days with an average call volume of 283K calls per minute. The example robocall campaign may reuse originating numbers for multiple calls and may use a similar area code as the destination number. The example robocall campaign may call the same destination number twice and may not be limited to a certain geographical location.

Returning to FIG. 2, the robocall campaign systems 129 may conduct more than one robocall campaign at a given time. Some of the robocall campaigns continue for months. Therefore, the campaign type analyzer 214 can use the robocall campaign features 300 to cluster the robocalls 124 into a campaign. An example clustering algorithm can use a variant of random forest to identify robocall campaign clusters 216. The robocall campaign clusters 216 are then used as an input for the robocall protection enrichment module 132.

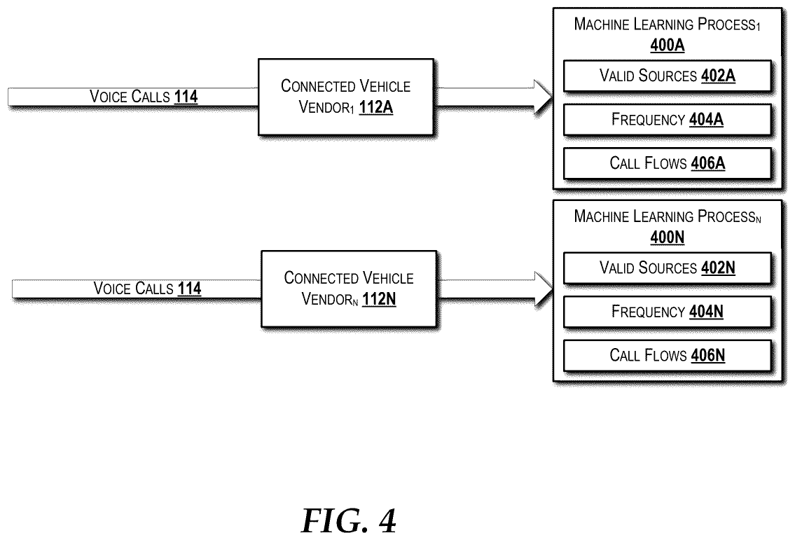

Turning now to FIG. 4, for each connected vehicle vendor 112A-112N, the robocall campaign detection module 128 can use machine learning processes 400A-400N to maintain a set of valid source phone numbers 402A-402N (“valid sources”) for each connected vehicle vendor 112, respectively. The valid sources 402A-402N can be determined by the statistical properties of how often the source numbers are used. Also, for each source number, the robocall campaign detection module 128 can learn a source's characteristics, such as frequency 404A-404N during the day, time of the day, and relation to the brand of vehicle. In some cases, a voice call 114 to a connected vehicle 104 follows a certain call flow 406A-406N, such as a short message service (“SMS”) message event prior to a voice call 114. For example, a roadside assistance service (e.g., one of the connected vehicle services 110) may be triggered by an SMS message from the connected vehicle 104 followed by a voice call 114 from the roadside assistance agent (e.g., one of the live agents 116) to the connected vehicle 104.

Some connected vehicle vendors 112 may not be a good fit to identify robocalls 124. For example, some connected vehicle vendors 112 do not support mobile terminated voice calls at all, and other connected vehicle vendors 112 frequently change the originating caller identity of the connected vehicle service 110 that calls the connected vehicle 104. The robocall mitigation system 122 can learn over time which connected vehicle vendors 112 provide more accurate robocall prediction and a lower false positive ratio, and can exclude the other connected vehicle vendors 112. FIG. 5 depicts an example of this feature.

Turning now to FIG. 5, the robocall mitigation system 122 can perform a false positive analysis 500 to determine whether to keep a connected vehicle vendor 112 or not for use in robocall mitigation operations. In particular, the false positive analysis 500 can determine whether the data associated with voice calls 114 associated with a connected vehicle vendor 112 results in a false positive outcome less than a threshold percentage (502). For example, if the percentage of false positives (i.e., incorrectly labeled robocall) generated from the data associated with the voice calls 114 associated with the connected vehicle vendor₁ 112A is less than or equal to 5%, then the false positive analysis 500 would yield a result to keep the connected vehicle vendor₁ 112A (504). If the percentage of false positive generated from the data associated with voice calls 114 associated with the connected vehicle vendor₁ 112A is greater than 5%, then the false positive analysis 500 would yield a result to exclude the connected vehicle vendor₁ 112A (506).

Returning to FIG. 2, the connected vehicle robocall blocking module 130 can receive the robocall alert records 212 from the robocall campaign detection module 128. The connected vehicle robocall blocking module 130 can determine, from the robocall alert records 212, whether or not to block a suspected robocall. Normally, an unauthorized number would be considered a robocall 124, still, there is a chance that the connected vehicle vendor 112 made a change and did not update the vendor authorized phone numbers 202.

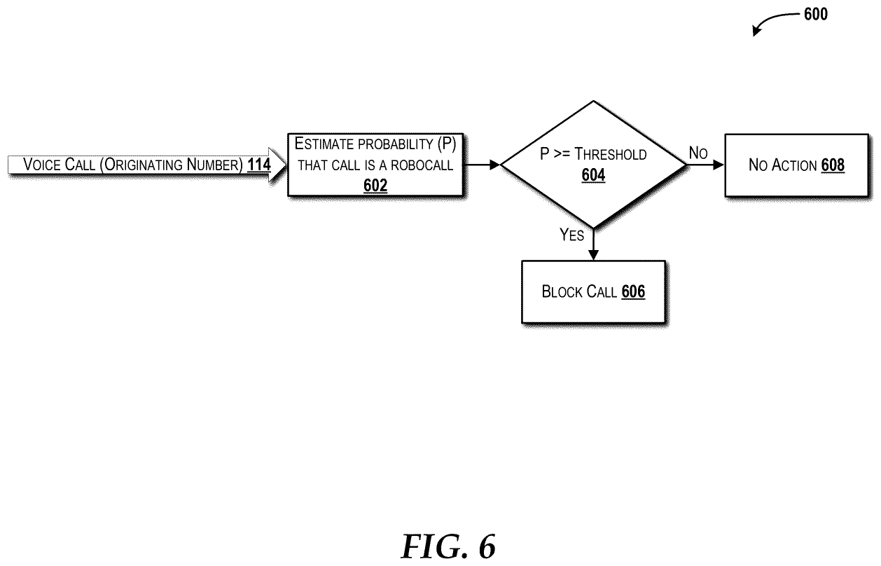

Turning now to FIG. 6, the connected vehicle robocall blocking module 130 can execute a robocall blocking algorithm 600 that estimates whether a certain voice call 114 is a robocall 124. The robocall blocking algorithm 600 can estimate (602) a probability (P) that a given voice call 114 is a robocall 124. If the P is greater than or equal to a specified threshold (604), then the robocall blocking algorithm 600 can instruct the connected vehicle robocall blocking module 130 to block (606) that voice call 114. If, however, the P is less than the threshold, then the robocall blocking algorithm 600 can instruct the connected vehicle robocall blocking module 130 to take no action (608) for that voice call 114.

A parameter (may be weighted) that may be considered by the connected vehicle robocall blocking module 130 is whether the voice call 114 is associated with a robocall campaign or not, which can be received from the robocall campaign detection module 128. If the voice call 114 is determined to be associated with an active robocall campaign, the connected vehicle robocall blocking module 130 can determine to block the voice call 114. If it is not, the connected vehicle robocall blocking module 130 can tag the voice call 114 and take no action. Over time, the connected vehicle robocall blocking module 130 can learn how dynamic the vendor authorized phone numbers 202 in the allow list 200 are and can decide whether to block voice calls 114 associated with an unknown number based upon the probability that an unknown number is indeed authorized.

The connected vehicle robocall blocking module 130 can enforce the blocking action at a Mobility Management Entity (“MME”) for LTE core networks or an Access and Mobility Management Function (“AMF”) 5G core networks assuming that these network functions support a Mobile Station Integrated Services Digital Network (“MSISDN”) feature. There may be other core architecture functions where a blacklist feature could be implemented, such as at the Serving Gateway (“S-GW”) or 5G Session Management Function (“SMF”) or a Policy and Charging Rules Function (“PCRF”) or a 5G Policy Control Function (“PCF”).

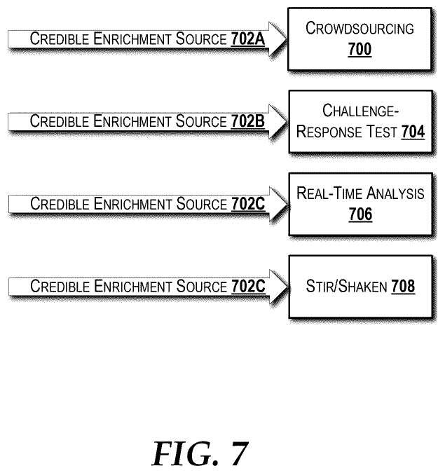

Returning to FIG. 1, the robocall protection enrichment module 132 can add information to an external robocall blocking system 134, which can implement commercial robocall protection solutions based on a set of techniques, of which each can benefit from the suspicious robocalls numbers generated from monitoring the connected vehicles 104 in accordance with the concepts and technologies disclosed herein. The primary techniques currently used by commercial robocall protection solutions are shown in FIG. 7, which will now be described.

A crowdsourcing technique 700 can receive reports from subscribers about robocalls. This technique relies on subscriber participation and the credibility of the reports. Using connected vehicles 104 as a credible enrichment source 702A ensures a credible large crowd that would always participate in reporting.

A challenge-response test 704 can apply a check for suspected numbers that would require callers to respond (shown as credible enrichment source 702B) to a challenge prior to establishing a voice call 114. An advantage of the challenge-response test is that if there are false positives, the voice call 114 is not blocked. The downside is that it may be expensive to apply this mechanism to all suspected robocalls. Since the connected vehicles 104 monitoring is already considered with a high credibility, the challenge-response test 704 can be avoided for these numbers.

A real-time analysis method 706 can perform caller behavior analysis to identify abnormal callers. The real-time analysis method 706 works along with blacklisting and crowdsourcing reports and can improve its accuracy from the reports generated by connected vehicles 104.

A STIR/SHAKEN technique 708 helps authenticate caller ID spoofing to limit and block robocalls 124. By using connected vehicle-based robocall monitoring, the use of the STIR/SHAKEN technique 708 can be reduced or avoided altogether, and therefore the connected vehicle-based robocall monitoring described herein can complement the STIR/SHAKEN technique in helping to identify the source of voice calls 114.

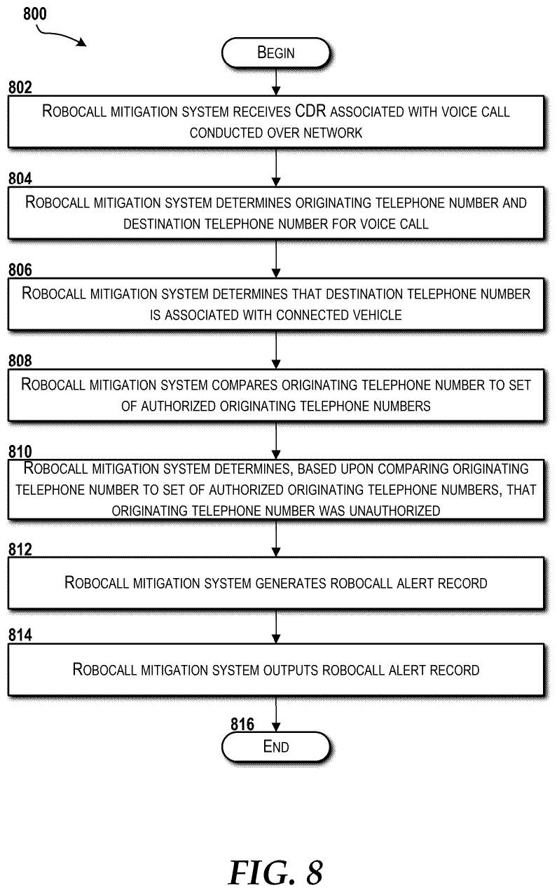

Turning now to FIG. 8, a method 800 for mitigating robocalls 124 using connected vehicles 104 will be described, according to an illustrative embodiment of the concepts and technologies disclosed herein. It should be understood that the operations of the method disclosed herein are not necessarily presented in any particular order and that performance of some or all of the operations in an alternative order(s) is possible and is contemplated. The operations have been presented in the demonstrated order for ease of description and illustration. Operations may be added, omitted, and/or performed simultaneously, without departing from the scope of the concepts and technologies disclosed herein.

It also should be understood that the method disclosed herein can be ended at any time and need not be performed in its entirety. Some or all operations of the method, and/or substantially equivalent operations, can be performed by execution of computer-readable instructions included on a computer storage media, as defined herein. The term “computer-readable instructions,” and variants thereof, as used herein, is used expansively to include routines, applications, application modules, program modules, programs, components, data structures, algorithms, and the like. Computer-readable instructions can be implemented on various system configurations including single-processor or multiprocessor systems, minicomputers, mainframe computers, personal computers, hand-held computing devices, microprocessor-based, programmable consumer electronics, combinations thereof, and the like.

Thus, it should be appreciated that the logical operations described herein are implemented (1) as a sequence of computer implemented acts or program modules running on a computing system and/or (2) as interconnected machine logic circuits or circuit modules within the computing system. The implementation is a matter of choice dependent on the performance and other requirements of the computing system. Accordingly, the logical operations described herein are referred to variously as states, operations, structural devices, acts, or modules. These states, operations, structural devices, acts, and modules may be implemented in software, in firmware, in special purpose digital logic, and any combination thereof. As used herein, the phrase “cause a processor to perform operations” and variants thereof is used to refer to causing a processor of a computing system or device, or a portion thereof, to perform one or more operations, and/or causing the processor to direct other components of the computing system or device to perform one or more of the operations.

For purposes of illustrating and describing the concepts of the present disclosure, operations of the method disclosed herein are described as being performed alone or in combination via execution of one or more software modules, and/or other software/firmware components described herein. It should be understood that additional and/or alternative devices and/or network nodes can provide the functionality described herein via execution of one or more modules, applications, and/or other software. Thus, the illustrated embodiments are illustrative, and should not be viewed as being limiting in any way.

The method 800 begins and proceeds to operation 802. At operation 802, the robocall mitigation system 122 can receive one of the CDRs 120 associated with one of the voice calls 114 conducted over the network(s) 106. In implementations, the robocall mitigation system 122 can receive multiple CDRs 120 associated with multiple voice calls 114 conducted over the network(s) 106. Each of the CDRs 120 can identify an originating telephone number of the voice call 114, an originating party of the voice call 114, a destination telephone number of the voice call 114, a destination party of the voice call 114, a date and a time the voice call 114 was made, a duration of the voice call 114, and other usage and diagnostic information.

From operation 802, the method 800 proceeds to operation 804. At operation 804, the robocall mitigation system 122 can determine, by the robocall campaign detection module 128, from the CDR 120, an originating telephone number and a destination telephone number for the voice call 114. From operation 804, the method 800 can proceed to operation 806. At operation 806, the robocall mitigation system 122 can determine, by the robocall campaign detection module 128, that the destination telephone number is associated with one of the connected vehicles 104.

From operation 806, the method 800 proceeds to operation 808. At operation 808, the robocall mitigation system 122 can compare, by the robocall campaign detection module 128, the originating telephone number to a set of authorized originating telephone numbers. The set of authorized originating telephone numbers can be associated with a specific connected vehicle vendor 112. As such, the set of authorized originating telephone numbers can be the vendor authorized phone numbers 202 (best shown in FIG. 2).

From operation 808, the method 800 proceeds to operation 810. At operation 810, the robocall mitigation system 122 can determine, by the robocall campaign detection module 128, based upon comparing the originating telephone number to the set of authorized originating telephone numbers, that the originating telephone number was unauthorized. From operation 810, the method 800 proceeds to operation 812. At operation 812, the robocall mitigation system 122 can generate, by the robocall campaign detection module 128, a robocall alert record 212. From operation 812, the method 800 proceeds to operation 814. At operation 814, the robocall mitigation system 122 can output, by the robocall campaign detection module 128, the robocall alert record 212.

From operation 814, the method 800 proceeds to operation 816. The method 800 can end at operation 816.

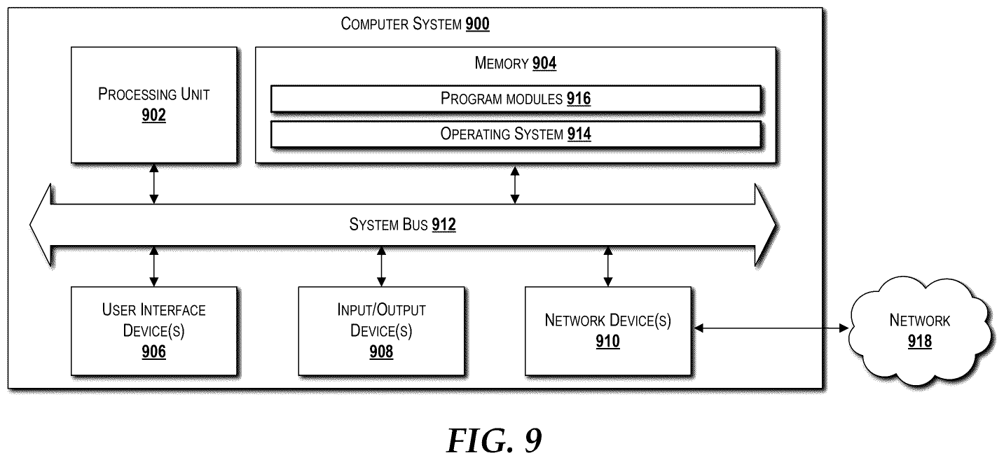

Turning now to FIG. 9, a block diagram illustrating a computer system 900 configured to provide the functionality described herein in accordance with various embodiments. In some embodiments, one or more of the vehicle system(s)/sensor(s) 120, the user device(s) 126, the robocall mitigation system 122, and/or other systems/devices described herein can be configured the same as or similar to the computer system 900.

The computer system 900 includes a processing unit 902, a memory 904, one or more user interface devices 906, one or more input/output (“I/O”) devices 908, and one or more network devices 910, each of which is operatively connected to a system bus 912. The bus 912 enables bi-directional communication between the processing unit 902, the memory 904, the user interface devices 906, the I/O devices 908, and the network devices 910.

The processing unit 902 may be a standard central processor that performs arithmetic and logical operations, a more specific purpose programmable logic controller (“PLC”), a programmable gate array, or other type of processor known to those skilled in the art and suitable for controlling the operation of the server computer. The processing unit 902 can be a single processing unit or a multiple processing unit that includes more than one processing component. Processing units are generally known, and therefore are not described in further detail herein.

The memory 904 communicates with the processing unit 902 via the system bus 912. The memory 904 can include a single memory component or multiple memory components. In some embodiments, the memory 904 is operatively connected to a memory controller (not shown) that enables communication with the processing unit 902 via the system bus 912. The memory 904 includes an operating system 914 and one or more program modules 916. The operating system 914 can include, but is not limited to, members of the WINDOWS family of operating systems from MICROSOFT CORPORATION, the LINUX family of operating systems, families of operating systems from APPLE CORPORATION, other operating systems, and/or the like.

The program modules 916 may include various software and/or program modules described herein. In some embodiments, multiple implementations of the computer system 900 can be used, wherein each implementation is configured to execute one or more of the program modules 916. The program modules 916 and/or other programs can be embodied in computer-readable media containing instructions that, when executed by the processing unit 902, perform the method 800 described herein. According to embodiments, the program modules 916 may be embodied in hardware, software, firmware, or any combination thereof.

By way of example, and not limitation, computer-readable media may include any available computer storage media or communication media that can be accessed by the computer system 900. Communication media includes computer-readable instructions, data structures, program modules, or other data in a modulated data signal such as a carrier wave or other transport mechanism and includes any delivery media. The term “modulated data signal” means a signal that has one or more of its characteristics changed or set in a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

Computer storage media includes volatile and non-volatile, removable and non-removable media implemented in any method or technology for storage of information such as computer-readable instructions, data structures, program modules, or other data. Computer storage media includes, but is not limited to, random access memory (“RAM”), read-only memory (“ROM”), Erasable Programmable ROM (“EPROM”), Electrically Erasable Programmable ROM (“EEPROM”), flash memory or other solid state memory technology, CD-ROM, digital versatile disks (“DVD”), or other optical storage, magnetic cassettes, magnetic tape, magnetic disk storage or other magnetic storage devices, or any other medium which can be used to store the desired information and which can be accessed by the computer system 900. In the claims, the phrase “computer storage medium,” “computer-readable storage medium,” and variations thereof does not include waves or signals per se and/or communication media, and therefore should be construed as being directed to “non-transitory” media only.

The user interface devices 906 may include one or more devices with which a user accesses the computer system 900. The user interface devices 906 may include, but are not limited to, computers, servers, personal digital assistants, cellular phones, or any suitable computing devices. The I/O devices 908 enable a user to interface with the program modules 916. In one embodiment, the I/O devices 908 are operatively connected to an I/O controller (not shown) that enables communication with the processing unit 902 via the system bus 912. The I/O devices 908 may include one or more input devices, such as, but not limited to, a keyboard, a mouse, or an electronic stylus. Further, the I/O devices 908 may include one or more output devices, such as, but not limited to, a display or printer.

The network devices 910 enable the computer system 900 to communicate with other networks or remote systems via the network(s) 918, such as the network(s) 106. Examples of the network devices 910 include, but are not limited to, a modem, a radio frequency (“RF”) or infrared (“IR”) transceiver, a telephonic interface, a bridge, a router, or a network card. The network 918 may include a wireless network such as, but not limited to, a Wireless Local Area Network (“WLAN”) such as a WI-FI network, a Wireless Wide Area Network (“WWAN”), a Wireless Personal Area Network (“WPAN”) such as BLUETOOTH, a Wireless Metropolitan Area Network (“WMAN”) such as a WiMAX network, or a cellular network. Additionally, the network 918 can be or can include a wired network such as, but not limited to, a Wide Area Network (“WAN”) such as the Internet, a Local Area Network (“LAN”) such as the Ethernet, a wired Personal Area Network (“PAN”), or a wired Metropolitan Area Network (“MAN”).

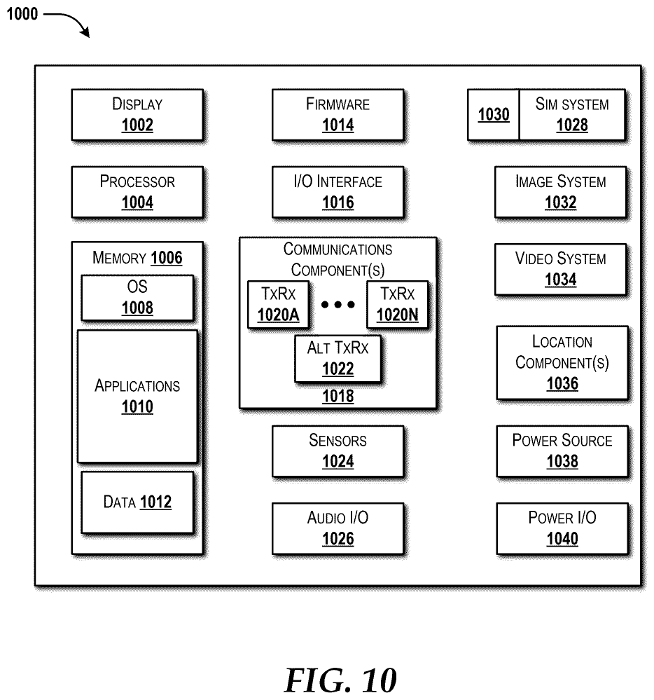

Turning now to FIG. 10, an illustrative mobile device 1000 and components thereof will be described. In some embodiments, the user device(s) 126 can be configured the same as or similar to the mobile device 1000. While connections are not shown between the various components illustrated in FIG. 10, it should be understood that some, none, or all of the components illustrated in FIG. 10 can be configured to interact with one another to carry out various device functions. In some embodiments, the components are arranged so as to communicate via one or more busses (not shown). Thus, it should be understood that FIG. 10 and the following description are intended to provide a general understanding of a suitable environment in which various aspects of embodiments can be implemented, and should not be construed as being limiting in any way.

As illustrated in FIG. 10, the mobile device 1000 can include a display 1002 for displaying data. According to various embodiments, the display 1002 can be configured to display various GUI elements, text, images, video, virtual keypads and/or keyboards, messaging data, notification messages, metadata, Internet content, device status, time, date, calendar data, device preferences, map and location data, combinations thereof, and/or the like. The mobile device 1000 can also include a processor 1004 and a memory or other data storage device (“memory”) 1006. The processor 1004 can be configured to process data and/or can execute computer-executable instructions stored in the memory 1006. The computer-executable instructions executed by the processor 1004 can include, for example, an operating system 1008, one or more applications 1010, other computer-executable instructions stored in the memory 1006, or the like.

The UI application can interface with the operating system 1008 to facilitate user interaction with functionality and/or data stored at the mobile device 1000 and/or stored elsewhere. In some embodiments, the operating system 1008 can include a member of the IOS family of operating systems from APPLE INC., a member of the ANDROID OS family of operating systems from GOOGLE LLC, and/or other operating systems. These operating systems are merely illustrative of some contemplated operating systems that may be used in accordance with various embodiments of the concepts and technologies described herein and therefore should not be construed as being limiting in any way.

The UI application can be executed by the processor 1004 to aid a user in entering/deleting data, entering and setting user IDs and passwords for device access, configuring settings, manipulating content and/or settings, multimode interaction, interacting with other applications 1010, and otherwise facilitating user interaction with the operating system 1008, the applications 1010, and/or other types or instances of data 1012 that can be stored at the mobile device 1000.

The applications 1010, the data 1012, and/or portions thereof can be stored in the memory 1006 and/or in a firmware 1014, and can be executed by the processor 1004. The firmware 1014 can also store code for execution during device power up and power down operations. It can be appreciated that the firmware 1014 can be stored in a volatile or non-volatile data storage device including, but not limited to, the memory 1006 and/or a portion thereof.

The mobile device 1000 can also include an input/output (“I/O”) interface 1016. The I/O interface 1016 can be configured to support the input/output of data such as location information, presence status information, user IDs, passwords, and application initiation (start-up) requests. In some embodiments, the I/O interface 1016 can include a hardwire connection such as a universal serial bus (“USB”) port, a mini-USB port, a micro-USB port, an audio jack, a PS2 port, an IEEE 1394 (“FIREWIRE”) port, a serial port, a parallel port, an Ethernet (RJ45) port, an RJ11 port, a proprietary port, combinations thereof, or the like. In some embodiments, the mobile device 1000 can be configured to synchronize with another device to transfer content to and/or from the mobile device 1000. In some embodiments, the mobile device 1000 can be configured to receive updates to one or more of the applications 1010 via the I/O interface 1016, though this is not necessarily the case. In some embodiments, the I/O interface 1016 accepts I/O devices such as keyboards, keypads, mice, interface tethers, printers, plotters, external storage, touch/multi-touch screens, touch pads, trackballs, joysticks, microphones, remote control devices, displays, projectors, medical equipment (e.g., stethoscopes, heart monitors, and other health metric monitors), modems, routers, external power sources, docking stations, combinations thereof, and the like. It should be appreciated that the I/O interface 1016 may be used for communications between the mobile device 1000 and a network device or local device.

The mobile device 1000 can also include a communications component 1018. The communications component 1018 can be configured to interface with the processor 1004 to facilitate wired and/or wireless communications with one or more networks, such as the network(s) 106, the Internet, or some combination thereof. In some embodiments, the communications component 1018 includes a multimode communications subsystem for facilitating communications via the cellular network and one or more other networks.

The communications component 1018, in some embodiments, includes one or more transceivers. The one or more transceivers, if included, can be configured to communicate over the same and/or different wireless technology standards with respect to one another. For example, in some embodiments, one or more of the transceivers of the communications component 1018 may be configured to communicate using Global System for Mobile communications (“GSM”), Code-Division Multiple Access (“CDMA”) CDMAONE, CDMA2000, Long-Term Evolution (“LTE”) LTE, and various other 2G, 2.5G, 3G, 4G, 5G, 6G, and greater generation technology standards. Moreover, the communications component 1018 may facilitate communications over various channel access methods (which may or may not be used by the aforementioned standards) including, but not limited to, Time-Division Multiple Access (“TDMA”), Frequency-Division Multiple Access (“FDMA”), Wideband CDMA (“W-CDMA”), Orthogonal Frequency-Division Multiple Access (“OFDMA”), Space-Division Multiple Access (“SDMA”), and the like.

In addition, the communications component 1018 may facilitate data communications using General Packet Radio Service (“GPRS”), Enhanced Data services for Global Evolution (“EDGE”), the High-Speed Packet Access (“HSPA”) protocol family including High-Speed Downlink Packet Access (“HSDPA”), Enhanced Uplink (“EUL”) (also referred to as High-Speed Uplink Packet Access (“HSUPA”), HSPA+, and various other current and future wireless data access standards. In the illustrated embodiment, the communications component 1018 can include a first transceiver (“TxRx”) 1020A that can operate in a first communications mode (e.g., GSM). The communications component 1018 can also include an Nth transceiver (“TxRx”) 1020N that can operate in a second communications mode relative to the first transceiver 1020A (e.g., UMTS). While two transceivers 1020A-1020N (hereinafter collectively and/or generically referred to as “transceivers 1020”) are shown in FIG. 10, it should be appreciated that less than two, two, and/or more than two transceivers 1020 can be included in the communications component 1018.

The communications component 1018 can also include an alternative transceiver (“Alt TxRx”) 1022 for supporting other types and/or standards of communications. According to various contemplated embodiments, the alternative transceiver 1022 can communicate using various communications technologies such as, for example, WI-FI, WIMAX, BLUETOOTH, infrared, infrared data association (“IRDA”), near field communications (“NFC”), other RF technologies, combinations thereof, and the like. In some embodiments, the communications component 1018 can also facilitate reception from terrestrial radio networks, digital satellite radio networks, internet-based radio service networks, combinations thereof, and the like. The communications component 1018 can process data from a network such as the Internet, an intranet, a broadband network, a WI-FI hotspot, an Internet service provider (“ISP”), a digital subscriber line (“DSL”) provider, a broadband provider, combinations thereof, or the like.

The mobile device 1000 can also include one or more sensors 1024. The sensors 1024 can include temperature sensors, light sensors, air quality sensors, movement sensors, accelerometers, magnetometers, gyroscopes, infrared sensors, orientation sensors, noise sensors, microphones proximity sensors, combinations thereof, and/or the like. Additionally, audio capabilities for the mobile device 1000 may be provided by an audio I/O component 1026. The audio I/O component 1026 of the mobile device 1000 can include one or more speakers for the output of audio signals, one or more microphones for the collection and/or input of audio signals, and/or other audio input and/or output devices.

The illustrated mobile device 1000 can also include a subscriber identity module (“SIM”) system 1028. The SIM system 1028 can include a universal SIM (“USIM”), a universal integrated circuit card (“UICC”), eSIM, and/or other identity devices. The SIM system 1028 can include and/or can be connected to or inserted into an interface such as a slot interface 1030. In some embodiments, the slot interface 1030 can be configured to accept insertion of other identity cards or modules for accessing various types of networks. Additionally, or alternatively, the slot interface 1030 can be configured to accept multiple subscriber identity cards. Because other devices and/or modules for identifying users and/or the mobile device 1000 are contemplated, it should be understood that these embodiments are illustrative, and should not be construed as being limiting in any way.

The mobile device 1000 can also include an image capture and processing system 1032 (“image system”). The image system 1032 can be configured to capture or otherwise obtain photos, videos, and/or other visual information. As such, the image system 1032 can include cameras, lenses, charge-coupled devices (“CCDs”), combinations thereof, or the like. The mobile device 1000 may also include a video system 1034. The video system 1034 can be configured to capture, process, record, modify, and/or store video content. Photos and videos obtained using the image system 1032 and the video system 1034, respectively, may be added as message content to an MMS message, email message, and sent to another device. The video and/or photo content can also be shared with other devices via various types of data transfers via wired and/or wireless communication devices as described herein.

The mobile device 1000 can also include one or more location components 1036. The location components 1036 can be configured to send and/or receive signals to determine a geographic location of the mobile device 1000. According to various embodiments, the location components 1036 can send and/or receive signals from global positioning system (“GPS”) devices, assisted-GPS (“A-GPS”) devices, WI-FI/WIMAX and/or cellular network triangulation data, combinations thereof, and the like. The location component 1036 can also be configured to communicate with the communications component 1018 to retrieve triangulation data for determining a location of the mobile device 1000. In some embodiments, the location component 1036 can interface with cellular network nodes, telephone lines, satellites, location transmitters and/or beacons, wireless network transmitters and receivers, combinations thereof, and the like. In some embodiments, the location component 1036 can include and/or can communicate with one or more of the sensors 1024 such as a compass, an accelerometer, and/or a gyroscope to determine the orientation of the mobile device 1000. Using the location component 1036, the mobile device 1000 can generate and/or receive data to identify its geographic location, or to transmit data used by other devices to determine the location of the mobile device 1000. The location component 1036 may include multiple components for determining the location and/or orientation of the mobile device 1000.

The illustrated mobile device 1000 can also include a power source 1038. The power source 1038 can include one or more batteries, power supplies, power cells, and/or other power subsystems including alternating current (“AC”) and/or direct current (“DC”) power devices. The power source 1038 can also interface with an external power system or charging equipment via a power I/O component 1040. Because the mobile device 1000 can include additional and/or alternative components, the above embodiment should be understood as being illustrative of one possible operating environment for various embodiments of the concepts and technologies described herein. The described embodiment of the mobile device 1000 is illustrative, and should not be construed as being limiting in any way.

As used herein, communication media includes computer-executable instructions, data structures, program modules, or other data in a modulated data signal such as a carrier wave or other transport mechanism and includes any delivery media. The term “modulated data signal” means a signal that has one or more of its characteristics changed or set in a manner as to encode information in the signal. By way of example, and not limitation, communication media includes wired media such as a wired network or direct-wired connection, and wireless media such as acoustic, RF, infrared, and other wireless media. Combinations of the any of the above should also be included within the scope of computer-readable media.

By way of example, and not limitation, computer storage media may include volatile and non-volatile, removable and non-removable media implemented in any method or technology for storage of information such as computer-executable instructions, data structures, program modules, or other data. For example, computer media includes, but is not limited to, RAM, ROM, EPROM, EEPROM, flash memory or other solid state memory technology, CD-ROM, digital versatile disks (“DVD”), HD-DVD, BLU-RAY, or other optical storage, magnetic cassettes, magnetic tape, magnetic disk storage or other magnetic storage devices, or any other medium which can be used to store the desired information and which can be accessed by the mobile device 1000 or other devices or computers described herein, such as the computer system 900 described above with reference to FIG. 9. In the claims, the phrase “computer storage medium,” “computer-readable storage medium,” and variations thereof does not include waves or signals per se and/or communication media, and therefore should be construed as being directed to “non-transitory” media only.

Encoding the software modules presented herein also may transform the physical structure of the computer-readable media presented herein. The specific transformation of physical structure may depend on various factors, in different implementations of this description. Examples of such factors may include, but are not limited to, the technology used to implement the computer-readable media, whether the computer-readable media is characterized as primary or secondary storage, and the like. For example, if the computer-readable media is implemented as semiconductor-based memory, the software disclosed herein may be encoded on the computer-readable media by transforming the physical state of the semiconductor memory. For example, the software may transform the state of transistors, capacitors, or other discrete circuit elements constituting the semiconductor memory. The software also may transform the physical state of such components in order to store data thereupon.

As another example, the computer-readable media disclosed herein may be implemented using magnetic or optical technology. In such implementations, the software presented herein may transform the physical state of magnetic or optical media, when the software is encoded therein. These transformations may include altering the magnetic characteristics of particular locations within given magnetic media. These transformations also may include altering the physical features or characteristics of particular locations within given optical media, to change the optical characteristics of those locations. Other transformations of physical media are possible without departing from the scope and spirit of the present description, with the foregoing examples provided only to facilitate this discussion.

In light of the above, it should be appreciated that many types of physical transformations may take place in the mobile device 1000 in order to store and execute the software components presented herein. It is also contemplated that the mobile device 1000 may not include all of the components shown in FIG. 10, may include other components that are not explicitly shown in FIG. 10, or may utilize an architecture completely different than that shown in FIG. 10.

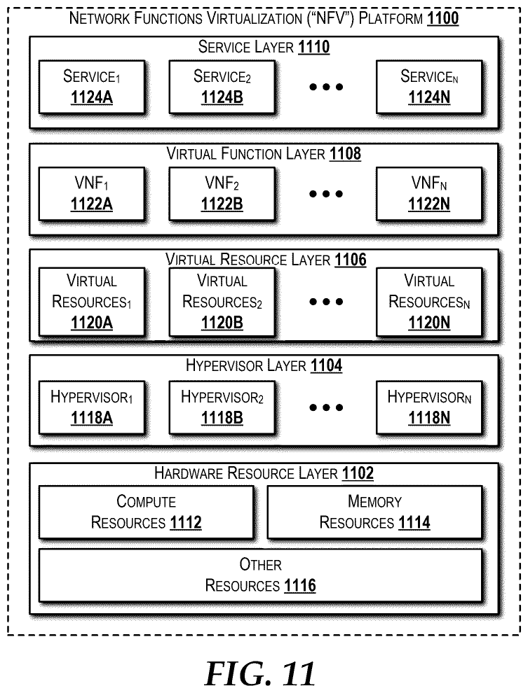

Turning now to FIG. 11, an illustrative network functions virtualization (“NFV”) platform 1100 will be described, according to an illustrative embodiment. In some embodiments, the network(s) 106 is/are built, at least in part, upon the NFV platform 1100. The NFV platform 1100 includes a hardware resource layer 1102, a hypervisor layer 1104, a virtual resource layer 1106, a virtual function layer 1108, and a service layer 1110. While no connections are shown between the layers illustrated in FIG. 11, it should be understood that some, none, or all of the components illustrated in FIG. 11 can be configured to interact with one other to carry out various functions described herein. In some embodiments, the components are arranged so as to communicate via one or more networks. Thus, it should be understood that FIG. 11 and the remaining description are intended to provide a general understanding of a suitable environment in which various aspects of the embodiments described herein can be implemented and should not be construed as being limiting in any way.

The hardware resource layer 1102 includes one or more compute resources 1112, one or more memory resources 1114, and one or more other resources 1116. The compute resource(s) 1112 can include one or more hardware components that perform computations to process data and/or to execute computer-executable instructions of one or more application programs, one or more operating systems, and/or other software. In particular, the compute resources 1112 can include one or more CPUs configured with one or more processing cores. The compute resources 1112 can include one or more GPUs configured to accelerate operations performed by one or more CPUs, and/or to perform computations to process data, and/or to execute computer-executable instructions of one or more application programs, one or more operating systems, and/or other software that may or may not include instructions particular to graphics computations. In some embodiments, the compute resources 1112 can include one or more discrete GPUs. In some other embodiments, the compute resources 1112 can include CPU and GPU components that are configured in accordance with a co-processing CPU/GPU computing model, wherein the sequential part of an application executes on the CPU and the computationally-intensive part is accelerated by the GPU processing capabilities. The compute resources 1112 can include one or more SoC components along with one or more other components, including, for example, one or more of the memory resources 1114, and/or one or more of the other resources 1116. In some embodiments, the compute resources 1112 can be or can include one or more SNAPDRAGON SoCs, available from QUALCOMM of San Diego, California; one or more TEGRA SoCs, available from NVIDIA of Santa Clara, California; one or more HUMMINGBIRD SoCs, available from SAMSUNG of Seoul, South Korea; one or more OMAP SoCs, available from TEXAS INSTRUMENTS of Dallas, Texas; one or more customized versions of any of the above SoCs; and/or one or more proprietary SoCs. The compute resources 1112 can be or can include one or more hardware components architected in accordance with an ARM architecture, available for license from ARM HOLDINGS of Cambridge, United Kingdom. Alternatively, the compute resources 1112 can be or can include one or more hardware components architected in accordance with an x86 architecture, such an architecture available from INTEL CORPORATION of Mountain View, California, and others. Those skilled in the art will appreciate the implementation of the compute resources 1112 can utilize various computation architectures, and as such, the compute resources 1112 should not be construed as being limited to any particular computation architecture or combination of computation architectures, including those explicitly disclosed herein.

The memory resource(s) 1114 can include one or more hardware components that perform storage/memory operations, including temporary or permanent storage operations. In some embodiments, the memory resource(s) 1114 include volatile and/or non-volatile memory implemented in any method or technology for storage of information such as computer-readable instructions, data structures, program modules, or other data disclosed herein. Computer storage media includes, but is not limited to, RAM, ROM, EPROM, EEPROM, flash memory or other solid state memory technology, CD-ROM, DVD, or other optical storage, magnetic cassettes, magnetic tape, magnetic disk storage or other magnetic storage devices, or any other medium which can be used to store data and which can be accessed by the compute resources 1112.

The other resource(s) 1116 can include any other hardware resources that can be utilized by the compute resources(s) 1112 and/or the memory resource(s) 1114 to perform operations described herein. The other resource(s) 1116 can include one or more input and/or output processors (e.g., network interface controller or wireless radio), one or more modems, one or more codec chipset, one or more pipeline processors, one or more fast Fourier transform (“FFT”) processors, one or more digital signal processors (“DSPs”), one or more speech synthesizers, and/or the like.

The hardware resources operating within the hardware resource layer 1102 can be virtualized by one or more hypervisors 1118A-1118N (also known as “virtual machine monitors”) operating within the hypervisor layer 1104 to create virtual resources that reside in the virtual resource layer 1106. The hypervisors 1116A-1116N can be or can include software, firmware, and/or hardware that alone or in combination with other software, firmware, and/or hardware, creates and manages virtual resources 1120A-1120N operating within the virtual resource layer 1106.

The virtual resources 1120A-1120N operating within the virtual resource layer 1106 can include abstractions of at least a portion of the compute resources 1112, the memory resources 1114, and/or the other resources 1116, or any combination thereof. In some embodiments, the abstractions can include one or more virtual machines, virtual volumes, virtual networks, and/or other virtualizes resources upon which one or more virtual network functions (“VNFs”) 1122A-1122N can be executed. The VNFs 1122A-1122N in the virtual function layer 1108 are constructed out of the virtual resources 1120A-1120N in the virtual function layer 1108. In the illustrated example, the VNFs 1122A-1122N can provide, at least in part, one or more services 1124A-1124N in the service layer 1110.

Turning now to FIG. 12, details of a network 1200 are illustrated, according to an illustrative embodiment. In some embodiments, the network(s) 106 shown in FIG. 1 can be configured the same as or similar to the network 1200. The network 1200 includes a cellular network 1202, a packet data network 1204, and a circuit switched network 1206 (e.g., a public switched telephone network). The cellular network 1202 includes various components such as, but not limited to, base transceiver stations (“BTSs”), Node-Bs or e-Node-Bs, base station controllers (“BSCs”), radio network controllers (“RNCs”), mobile switching centers (“MSCs”), mobility management entities (“MMEs”), short message service centers (“SMSCs”), multimedia messaging service centers (“MMSCs”), home location registers (“HLRs”), home subscriber servers (“HSSs”), visitor location registers (“VLRs”), charging platforms, billing platforms, voicemail platforms, GPRS core network components, location service nodes, and the like. The cellular network 1202 also includes radios and nodes for receiving and transmitting voice, data, and combinations thereof to and from radio transceivers, networks, the packet data network 1204, and the circuit switched network 1206.

A mobile communications device 1208, such as, for example, the user device(s) 126, a cellular telephone, a user equipment, a mobile terminal, a PDA, a laptop computer, a handheld computer, and combinations thereof, can be operatively connected to the cellular network 1202. The mobile communications device 1208 can be configured similar to or the same as the mobile device 1000 described above with reference to FIG. 10.

The cellular network 1202 can be configured as a GSM network and can provide data communications via GPRS and/or EDGE. Additionally, or alternatively, the cellular network 1202 can be configured as a 3G Universal Mobile Telecommunications System (“UMTS”) network and can provide data communications via the HSPA protocol family, for example, HSDPA, EUL, and HSPA+. The cellular network 1202 also is compatible with mobile communications standards such as LTE, or the like, as well as evolved and future mobile standards.

The packet data network 1204 includes various systems, devices, servers, computers, databases, and other devices in communication with one another, as is generally known. In some embodiments, the packet data network 1204 is or includes one or more WI-FI networks, each of which can include one or more WI-FI access points, routers, switches, and other WI-FI network components. The packet data network 1204 devices are accessible via one or more network links. The servers often store various files that are provided to a requesting device such as, for example, a computer, a terminal, a smartphone, or the like. Typically, the requesting device includes software for executing a web page in a format readable by the browser or other software. Other files and/or data may be accessible via “links” in the retrieved files, as is generally known. In some embodiments, the packet data network 1204 includes or is in communication with the Internet. The circuit switched network 1206 includes various hardware and software for providing circuit switched communications. The circuit switched network 1206 may include, or may be, what is often referred to as a plain old telephone system (“POTS”). The functionality of a circuit switched network 1206 or other circuit-switched network are generally known and will not be described herein in detail.

The illustrated cellular network 1202 is shown in communication with the packet data network 1204 and a circuit switched network 1206, though it should be appreciated that this is not necessarily the case. One or more Internet-capable systems/devices 1210 such as a laptop, a portable device, or another suitable device, can communicate with one or more cellular networks 1202, and devices connected thereto, through the packet data network 1204. It also should be appreciated that the Internet-capable device 1210 can communicate with the packet data network 1204 through the circuit switched network 1206, the cellular network 1202, and/or via other networks (not illustrated).

As illustrated, a communications device 1212, for example, a telephone, facsimile machine, modem, computer, or the like, can be in communication with the circuit switched network 1206, and therethrough to the packet data network 1204 and/or the cellular network 1202. It should be appreciated that the communications device 1212 can be an Internet-capable device, and can be substantially similar to the Internet-capable device 1210.

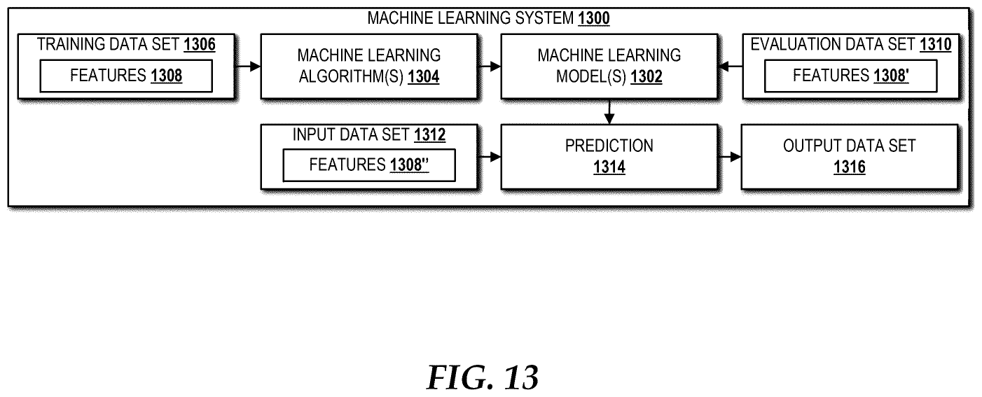

Turning now to FIG. 13, a machine learning system 1300 capable of implementing aspects of the embodiments disclosed herein will be described. In some embodiments, aspects of the robocall campaign detection module 128, the connected vehicle robocall blocking module 130, the robocall protection enrichment module 132, or a combination thereof can be improved via machine learning. Accordingly, or a combination thereof can include or can be in communication with a machine learning system 1300 or multiple machine learning systems 1300.

The illustrated machine learning system 1300 includes one or more machine learning models 1302. The machine learning models 1302 can include unsupervised, supervised, and/or semi-supervised learning models. The machine learning model(s) 1302 can be created by the machine learning system 1300 based upon one or more machine learning algorithms 1304. The machine learning algorithm(s) 1304 can be any existing, well-known algorithm, any proprietary algorithms, or any future machine learning algorithm. Some example machine learning algorithms 1304 include, but are not limited to, neural networks, gradient descent, linear regression, logistic regression, linear discriminant analysis, classification tree, regression tree, Naive Bayes, K-nearest neighbor, learning vector quantization, support vector machines, any of the algorithms described herein, and the like. Classification and regression algorithms might find particular applicability to the concepts and technologies disclosed herein. Those skilled in the art will appreciate the applicability of various machine learning algorithms 1304 based upon the problem(s) to be solved by machine learning via the machine learning system 1300.

The machine learning system 1300 can control the creation of the machine learning models 1302 via one or more training parameters. In some embodiments, the training parameters are selected modelers at the direction of an enterprise, for example. Alternatively, in some embodiments, the training parameters are automatically selected based upon data provided in one or more training data sets 1306. The training parameters can include, for example, a learning rate, a model size, a number of training passes, data shuffling, regularization, and/or other training parameters known to those skilled in the art.

The learning rate is a training parameter defined by a constant value. The learning rate affects the speed at which the machine learning algorithm 1304 converges to the optimal weights. The machine learning algorithm 1304 can update the weights for every data example included in the training data set 1306. The size of an update is controlled by the learning rate. A learning rate that is too high might prevent the machine learning algorithm 1304 from converging to the optimal weights. A learning rate that is too low might result in the machine learning algorithm 1304 requiring multiple training passes to converge to the optimal weights.

The model size is regulated by the number of input features (“features”) 1308 in the training data set 1306. A greater the number of features 1308 yields a greater number of possible patterns that can be determined from the training data set 1306. The model size should be selected to balance the resources (e.g., compute, memory, storage, etc.) needed for training and the predictive power of the resultant machine learning model 1302.

The number of training passes indicates the number of training passes that the machine learning algorithm 1304 makes over the training data set 1306 during the training process. The number of training passes can be adjusted based, for example, on the size of the training data set 1306, with larger training data sets being exposed to fewer training passes in consideration of time and/or resource utilization. The effectiveness of the resultant machine learning model 1302 can be increased by multiple training passes.

Data shuffling is a training parameter designed to prevent the machine learning algorithm 1304 from reaching false optimal weights due to the order in which data contained in the training data set 1306 is processed. For example, data provided in rows and columns might be analyzed first row, second row, third row, etc., and thus an optimal weight might be obtained well before a full range of data has been considered. By data shuffling, the data contained in the training data set 1306 can be analyzed more thoroughly and mitigate bias in the resultant machine learning model 1302.

Regularization is a training parameter that helps to prevent the machine learning model 1302 from memorizing training data from the training data set 1306. In other words, the machine learning model 1302 fits the training data set 1306, but the predictive performance of the machine learning model 1302 is not acceptable. Regularization helps the machine learning system 1300 avoid this overfitting/memorization problem by adjusting extreme weight values of the features 1308. For example, a feature that has a small weight value relative to the weight values of the other features in the training data set 1306 can be adjusted to zero.

The machine learning system 1300 can determine model accuracy after training by using one or more evaluation data sets 1310 containing the same features 1008′ as the features 1308 in the training data set 1306. This also prevents the machine learning model 1302 from simply memorizing the data contained in the training data set 1306. The number of evaluation passes made by the machine learning system 1300 can be regulated by a target model accuracy that, when reached, ends the evaluation process and the machine learning model 1302 is considered ready for deployment.

After deployment, the machine learning model 1302 can perform a prediction operation (“prediction”) 1314 with an input data set 1312 having the same features 1308″ as the features 1308 in the training data set 1306 and the features 1008′ of the evaluation data set 1310. The results of the prediction 1314 are included in an output data set 1316 consisting of predicted data. The machine learning model 1302 can perform other operations, such as regression, classification, and others. As such, the example illustrated in FIG. 13 should not be construed as being limiting in any way.

Based on the foregoing, it should be appreciated that aspects of mitigating robocalls using connected vehicles have been disclosed herein. Although the subject matter presented herein has been described in language specific to computer structural features, methodological and transformative acts, specific computing machinery, and computer-readable media, it is to be understood that the concepts and technologies disclosed herein are not necessarily limited to the specific features, acts, or media described herein. Rather, the specific features, acts and mediums are disclosed as example forms of implementing the concepts and technologies disclosed herein.

The subject matter described above is provided by way of illustration only and should not be construed as limiting. Various modifications and changes may be made to the subject matter described herein without following the example embodiments and applications illustrated and described, and without departing from the true spirit and scope of the embodiments of the concepts and technologies disclosed herein.

1. A method comprising:
receiving, by a robocall campaign detection module executed by a processor of a robocall mitigation system, a call detail record associated with a voice call conducted over a mobile telecommunications network;
determining, by the robocall campaign detection module, from the call detail record, an originating telephone number and a destination telephone number for the voice call;
determining, by the robocall campaign detection module, that the destination telephone number is associated with a connected vehicle;
comparing, by the robocall campaign detection module, the originating telephone number to a set of authorized originating telephone numbers;
determining, by the robocall campaign detection module, based upon comparing the originating telephone number to the set of authorized originating telephone numbers, that the originating telephone number was unauthorized;
generating, by the robocall campaign detection module, a robocall alert record; and
outputting, by the robocall campaign detection module, the robocall alert record.

2. The method of claim 1, further comprising:
determining, by the robocall campaign detection module, a set of robocall campaign features associated with a robocall campaign;
clustering, by the robocall campaign detection module using a clustering algorithm, based upon the set of robocall campaign features, the robocall alert record with additional robocall alert records; and
outputting, by the robocall campaign detection module, a robocall campaign cluster.

3. The method of claim 2, wherein outputting the robocall campaign cluster comprises outputting the robocall campaign cluster to a robocall protection enrichment module, and wherein the method further comprises adding, by the robocall protection enrichment module, robocall data associated with the robocall campaign cluster to a robocall protection technique implemented by an external robocall blocking system.

4. The method of claim 3, wherein the robocall protection technique comprises a crowdsourcing technique, a challenge-response test, a real-time analysis, or a stir/shaken technique.

5. The method of claim 2, wherein outputting the robocall campaign cluster comprises outputting the robocall campaign cluster to a connected vehicle robocall blocking module, and wherein the method further comprises blocking, by the connected vehicle robocall blocking module, a plurality of robocalls associated with the robocall campaign.

6. The method of claim 1, wherein outputting, by the robocall campaign detection module, the robocall alert record comprises outputting, by the robocall campaign detection module, the robocall alert record to a connected vehicle robocall blocking module; and wherein the method further comprises blocking, by the connected vehicle robocall blocking module, a plurality of robocalls associated with the originating telephone number and associated with a plurality of destination telephone numbers corresponding to a plurality of connected cars.

7. The method of claim 6, wherein blocking, by the connected vehicle robocall blocking module, the plurality of robocalls comprises blocking, by the connected vehicle robocall blocking module, the plurality of robocalls at a core network function of the mobile telecommunications network.

8. A system comprising:
a processor; and
a memory comprising computer-executable instructions that, when executed by the processor, cause the processor to perform operations comprising
receiving a call detail record associated with a voice call conducted over a mobile telecommunications network,
determining, from the call detail record, an originating telephone number and a destination telephone number for the voice call,
determining that the destination telephone number is associated with a connected vehicle,
comparing the originating telephone number to a set of authorized originating telephone numbers,
determining, based upon comparing the originating telephone number to the set of authorized originating telephone numbers, that the originating telephone number was unauthorized,
generating a robocall alert record, and
outputting the robocall alert record.

9. The system of claim 8, wherein the operations further comprise:
determining a set of robocall campaign features associated with a robocall campaign;
clustering, using a clustering algorithm, based upon the set of robocall campaign features, the robocall alert record with additional robocall alert records; and
outputting a robocall campaign cluster.

10. The system of claim 9, wherein outputting the robocall campaign cluster comprises outputting the robocall campaign cluster to a robocall protection enrichment module, and wherein the operations further comprise adding, by the robocall protection enrichment module, robocall data associated with the robocall campaign cluster to a robocall protection technique implemented by an external robocall blocking system.

11. The system of claim 10, wherein the robocall protection technique comprises a crowdsourcing technique, a challenge-response test, a real-time analysis, or a stir/shaken technique.

12. The system of claim 9, wherein outputting the robocall campaign cluster comprises outputting the robocall campaign cluster to a connected vehicle robocall blocking module, and wherein the operations further comprise blocking, by the connected vehicle robocall blocking module, a plurality of robocalls associated with the robocall campaign.

13. The system of claim 8, wherein outputting the robocall alert record comprises outputting the robocall alert record to a connected vehicle robocall blocking module, and wherein the operations further comprise blocking, by the connected vehicle robocall blocking module, a plurality of robocalls associated with the originating telephone number and associated with a plurality of destination telephone numbers corresponding to a plurality of connected cars.

14. The system of claim 13, wherein blocking, by the connected vehicle robocall blocking module, the plurality of robocalls comprises blocking, by the connected vehicle robocall blocking module, the plurality of robocalls at a core network function of the mobile telecommunications network.

15. A computer-readable storage medium having instructions stored thereon that, when executed by a processor, cause the processor to perform operations comprising:
receiving a call detail record associated with a voice call conducted over a mobile telecommunications network;
determining, from the call detail record, an originating telephone number and a destination telephone number for the voice call;
determining that the destination telephone number is associated with a connected vehicle;
comparing the originating telephone number to a set of authorized originating telephone numbers;
determining, based upon comparing the originating telephone number to the set of authorized originating telephone numbers, that the originating telephone number was unauthorized;
generating a robocall alert record; and
outputting the robocall alert record.

16. The computer-readable storage medium of claim 15, wherein the operations further comprise:
determining a set of robocall campaign features associated with a robocall campaign;
clustering, using a clustering algorithm, based upon the set of robocall campaign features, the robocall alert record with additional robocall alert records; and
outputting a robocall campaign cluster.

17. The computer-readable storage medium of claim 16, wherein outputting the robocall campaign cluster comprises outputting the robocall campaign cluster to a robocall protection enrichment module, and wherein the operations further comprise adding, by the robocall protection enrichment module, robocall data associated with the robocall campaign cluster to a robocall protection technique implemented by an external robocall blocking system.

18. The computer-readable storage medium of claim 17, wherein the robocall protection technique comprises a crowdsourcing technique, a challenge-response test, a real-time analysis, or a stir/shaken technique.

19. The computer-readable storage medium of claim 16, wherein outputting the robocall campaign cluster comprises outputting the robocall campaign cluster to a connected vehicle robocall blocking module, and wherein the operations further comprise blocking, by the connected vehicle robocall blocking module, a plurality of robocalls associated with the robocall campaign.

20. The computer-readable storage medium of claim 15, wherein outputting the robocall alert record comprises outputting the robocall alert record to a connected vehicle robocall blocking module, and wherein the operations further comprise blocking, by the connected vehicle robocall blocking module, a plurality of robocalls associated with the originating telephone number and associated with a plurality of destination telephone numbers corresponding to a plurality of connected cars.
